(19) United States
(12) Patent Application Publication
(10) Pub. No.: US 2008/0239573 A1
(43) Pub. Date: Oct. 2, 2008

(54) Head Slider, Head Support Unit and Disk Drive Apparatus

(76) Inventors: Zhisheng Deng, New Territories (HK); Yoshihiro Ueno, Osaka (JP)

Correspondence Address: RATNERPRESTIA, P.O. BOX 980, VALLEY FORGE, PA, 19482, US

(21) Appl. No.: 10/594,173

(22) PCT Filed: Jan. 23, 2006
(86) PCT No.: PCT/JP2006/300932

§ 371 Date: Sep. 26, 2006

(30) Foreign Application Priority Data
Jan. 26, 2005 (JP) 2005-018055

(51) Int. Cl. G11B 5/60

(52) U.S. Cl. 360/235.4

(57) ABSTRACT

A head slider which has a head part and which performs at least one of recording and reproducing by the head part in a state in which the head slider floats over a recording medium, which including: a first air bearing part which is disposed on an air inflow end side on a base surface; a second air bearing part which is disposed on an air outflow end side more than the first air bearing part on the base surface and which has the head part and has an area smaller than that of the first air bearing part; a pair of positive pressure generating parts which is disposed on both sides of a center axis of the head slider in the longitudinal direction closer to the air outflow end side than a step part formed of the first air bearing part and the base surface on the air inflow end side; a side rail parts which are disposed between the first air bearing part and one positive pressure generating part of the pair of positive pressure generating parts, and between the first air bearing part and the other positive pressure generating part of the pair of positive pressure generating parts; and an outside side rail parts which are disposed outside the pair of positive pressure generating parts with respect to the center axis of the head slider in the longitudinal direction.

### TECHNICAL FIELD

The present invention relates to a floating head slider, a head support unit using the floating head slider and a disk drive apparatus such as a magnetic disk drive apparatus mounted with the head support unit using the floating head slider.

### BACKGROUND ART

Heretofore, various techniques are proposed relating to a floating head slider for use in a disk drive apparatus such as a magnetic disk drive apparatus.

Particularly, in recent years, with the miniaturization of devices to be mounted and the higher density of a disk-shaped recording medium, since it is necessary to bring a magnetic head close to the disk-shaped recording medium, the required floating amount of the floating head slider from the disk-shaped recording medium is over a dozen nm, becoming considerably smaller.

In such a magnetic disk drive apparatus of a low floating amount, in the case in which an external impact is applied to that apparatus, there are problems that the head slider collides against the disk-shaped recording medium to magnetically and mechanically damage the disk-shaped recording medium, causing that recording and reproducing are likely to be impossible.

In view of these problems, in order to implement a floating head slider excellent in impact resistance, the shape of the surface facing the disk-shaped recording medium (hereinafter, referred to as an air lubrication surface) has been also considered variously.

For example, the applicants have already proposed a head slider in which an air bearing part is disposed on both of an air inflow end side and an air outflow end side on a base surface, the shapes of the surfaces of the two air bearing parts facing a recording medium are designed properly, and pressure generated from both of the air bearing parts is controlled to absorb an impact, whereby the head slider can be prevented from colliding against the recording medium. According to the head slider like this, when an impact is applied, the head slider rotates in the pitch direction to absorb the impact as it holds the positive pitch angle, whereby the head slider can be prevented from colliding against the recording medium, and a head slider can be provided which has a high impact resistance of about 1000 G (1 G=9.8 m/s²) (for example, see Japanese patent Unexamined Publication NO. 2002-288959).

However, in recent years, information devices are increasingly formed into mobile devices, a magnetic disk drive apparatus to be mounted on a mobile device is also demanded to have a higher impact resistance. For an example, it is demanded to implement a disk drive apparatus which can at least perform one of recording and reproducing of information even when the apparatus is directly dropped onto a concrete floor from a height of about 1.5 m high (it is supposed to be dropped from hands of a person standing) with no cushioning material between the disk drive apparatus and the information device.

### DISCLOSURE OF THE INVENTION

The invention has been made in view of the problems. There is provided a disk drive apparatus which can perform at least one of recording and reproducing of information even when the apparatus is directly dropped onto a concrete floor from a height of about 1.5 m high, for example, (it is supposed to be dropped from hands of a person standing) with no cushioning material between the disk drive apparatus and the information device, and a head slider and a head support unit which implement the disk drive apparatus.

A head slider according to the invention is a head slider which has a head part and which performs at least one of recording and reproducing by the head-part in a state in which the head slider floats over a recording medium, which including: a first air bearing part which is disposed on an air inflow end side on a base surface; a second air bearing part which is disposed on an air outflow end side more than the first air bearing part on the base surface and which has the head part and has an area smaller than that of the first air bearing part; a pair of positive pressure generating parts which is disposed on both sides of a center axis of the head slider in the longitudinal direction on the air outflow end side more than a step part formed between the first air bearing part and the base surface on the air inflow end side; a side rail parts which are disposed between the first air bearing part and one positive pressure generating part of the pair of positive pressure generating parts, and between the first air bearing part and the other positive pressure generating part of the pair of positive pressure generating parts; and an outside side rail parts which are disposed outside the pair of positive pressure generating parts with respect to the center axis of the head slider in the longitudinal direction.

According to the configuration like this, when an impact is applied, the pressure generated between the pair of positive pressure generating parts and the recording medium is greater than that in stable floating. Thus, the head slider can absorb an impact as it is rotated in the pitch direction as though it were supported by the pressure generated between the pair of positive pressure generating parts and the recording medium. Therefore, the configuration can be implemented in which no impact is generated between the head slider and the recording medium when a greater impact is applied, even when the apparatus is directly dropped onto a concrete floor from a height of about 1.5 m high, for example, (it is supposed to be dropped from hands of a person standing) with no cushioning material between the disk drive apparatus and the information device. The pressure generated between the first air bearing part and the recording medium is made higher than the pressure generated between the second air bearing part and the recording medium. Thus, a head slider can be implemented which can float in the state in which the positive pitch angle is held with respect to the recording surface of the recording medium. The side rail parts and the outside side rail parts control the air flow to generate higher pressure in the pair of positive pressure generating parts.

This configuration may be formed which further includes a first step part which is disposed between the base surface and the first air bearing part; and a second step part which is disposed between the base surface and the second air bearing part.

According to the configuration like this, a great step can be provided between the base surface and the first air bearing part, and between the base surface and the second air bearing part. Thus, in each of border portions thereof, a greater pressure can be generated.

This configuration may be formed in which a negative pressure generating part is provided in an area surrounded by the first air bearing part, the second air bearing part, and the side rail parts.

According to the configuration like this, further in the negative pressure generating part, the negative pressure can be generated efficiently.

This configuration may be formed in which the first air bearing part, the second air bearing part, the side rail parts, the outside side rail parts and the pair of positive pressure generating parts are formed at the same height from the base surface.

According to the configuration like this, further in fabrication, the surface of the base material is formed to be the surface which defines the first air bearing part, the second air bearing part, the side rail parts, the outside side rail parts and a pair of positive pressure generating parts. Thus, the configuration excellent in fabrication can be implemented.

This configuration may be formed in which the first step part and the second step part are formed at the same height from the base surface.

According to the configuration like this, it is further facilitated to produce the first step part and the second step part in the same process steps. Thus, the configuration further excellent in fabrication can be implemented.

This configuration may be formed in which distance D1 in the longitudinal direction from the air inflow end of the head slider to a border part of the pair of positive pressure generating parts on the air inflow end side satisfies a relationship below where a length of the head slider in the longitudinal direction is DT:

0.47≦(D1/DT)≦0.66

According to the configuration like this, the configuration can be further implemented in which when an impact is applied, the variation in the minimum space can be directed in the direction in which the head slider is separated from the recording medium.

This configuration may be formed in which distance D2 in the longitudinal direction from the air inflow end of the head slider to the step part of the first air bearing part satisfies a relationship below where a length of the head slider in the longitudinal direction is DT:

0.18≦(D2/DT)≦0.35

According to the configuration like this, the configuration can be further implemented in which when an impact is applied, the variation in the minimum space can be directed in the direction in which the head slider is separated from the recording medium.

Next, a head support unit according to the invention is a head support unit including: the head slider according to the invention; and a suspension which applies a predetermined thrusting force with respect to the head slider from a side opposite to a side on which the first air bearing part and the second air bearing part are disposed on the base surface.

According to the configuration like this, when an impact is applied, the pressure generated between the pair of positive pressure generating parts and the recording medium is greater than that in stable floating. Thus, the head slider can absorb an impact as it is rotated in the pitch direction as though it were supported by the pressure generated between the pair of positive pressure generating parts and the recording medium. Therefore, the configuration can be implemented in which no impact is generated between the head slider and the recording medium when a greater impact is applied, even when the apparatus is directly dropped onto a concrete floor from a height of about 1.5 m high, for example, (it is supposed to be dropped from hands of a person standing) with no cushioning material between the disk drive apparatus and the information device.

This configuration may be formed in which the suspension has a pivot part which applies the predetermined thrusting force with respect to the head slider.

According to the configuration like this, the configuration can be further implemented in which a predetermined thrusting force can be applied more efficiently with respect to the head slider.

Next, a disk drive apparatus according to the invention is a disk drive apparatus including: the head support unit according to the invention; a disk-shaped recording medium; a drive part which rotates and drives the disk-shaped recording medium; a rotating part which rotates the suspension of the head support unit in a radial direction of the disk-shaped recording medium; and a control part which controls the rotation and drive of the drive part and the rotation of the rotating part.

According to the configuration like this, when an impact is applied, the pressure generated between the pair of positive pressure generating parts and the recording medium is greater than that in stable floating. Thus, the head slider can absorb an impact as it is rotated in the pitch direction as though it were supported by the pressure generated between the pair of positive pressure generating parts and the recording medium. Therefore, the configuration can be implemented in which no impact is generated between the head slider and the recording medium when a greater impact is applied even when the apparatus is directly dropped onto a concrete floor from a height of about 1.5 m high, for example, (it is supposed to be dropped from hands of a person standing) with no cushioning material between the disk drive apparatus and the information device.

This configuration may be formed in which the suspension of the head support unit has a pivot part which applies a predetermined thrusting force with respect to the head slider;

wherein when a position at which the pivot part is abutted against the head slider is set to a pivot position, the position of the center of gravity and the pivot position of the head slider are projected onto the disk-shaped recording medium and these positions are matched with each other.

According to the configuration like this, the configuration of the most excellent impact resistance can be further implemented in which the generation of the moment of inertia is small when an impact is applied.

As described above, according to the invention, there can be provided a disk drive apparatus which can perform at least one of recording and reproducing of information even when the apparatus is directly dropped onto a concrete floor from a height of about 1.5 m high, for example, (it is supposed to be dropped from hands of a person standing) with no cushioning material between the disk drive apparatus and the information device, and a head slider and a head support unit which implement the disk drive apparatus like this.

### BRIEF DESCRIPTION OF THE DRAWINGS

FIG. 1 shows a front view depicting the shape of an air lubrication surface of a head slider according to a first embodiment of the invention;

FIG. 2A shows a back side view depicting the head slider according to the first embodiment of the invention;

FIG. 2B shows a left side view depicting the head slider according to the first embodiment of the invention;

FIG. 2C shows a right side view depicting the head slider according to the first embodiment of the invention;

FIG. 2D shows a plan view depicting the head slider according to the first embodiment of the invention;

FIG. 2E shows a bottom view depicting the head slider according to the first embodiment of the invention;

FIG. 3A shows a diagram depicting the behavior of the head slider according to the first embodiment of the invention in normal stable floating;

FIG. 3B shows a diagram depicting the behavior of the head slider according to the first embodiment of the invention when an external impact is applied thereto;

FIG. 4A shows a diagram depicting a pressure distribution generated between the head slider according to the first embodiment of the invention and a recording medium;

FIG. 4B shows a diagram depicting a pressure distribution generated between the head slider according to the first embodiment of the invention and the recording medium;

FIG. 5 shows a diagram depicting the relationship between the positions in the longitudinal direction of a first border part and a second border part of the head slider according to the first embodiment of the invention and the variations of the minimum space and the pitch angle when an impact is applied;

FIG. 6A shows a diagram depicting the configuration of an ABS surface of the head slider when the positions in the longitudinal direction of the first border part and the second border part according to the first embodiment of the invention are 0.4 mm from an air inflow end;

FIG. 6B shows a diagram depicting a pressure distribution of the head slider according to the first embodiment of the invention in normal floating:

FIG. 6C shows a diagram depicting a pressure distribution when an impact is applied to the head slider according to the first embodiment of the invention;

FIG. 6D shows a diagram depicting the configuration of the ABS surface of the head slider when the positions in the longitudinal direction of the first border part and the second border part according to the first embodiment of the invention are 0.56 mm from the air inflow end;

FIG. 6E shows a diagram depicting a pressure distribution of the head slider according to the first embodiment of the invention in normal floating;

FIG. 6F shows a diagram depicting a pressure distribution when an impact is applied to the head slider according to the first embodiment of the invention;

FIG. 7 shows a diagram depicting the relationship between the position of a step part of the head slider according to the first embodiment of the invention from the air inflow end and the variations of the pitch angle and the minimum space;

FIG. 8A shows a diagram depicting the configuration of the ABS surface of the head slider when the position in the longitudinal direction of the step part according to the first embodiment of the invention is 0.15 mm from the air inflow end;

FIG. 8B shows a diagram depicting a pressure distribution of the head slider according to the first embodiment of the invention in normal floating;

FIG. 8C shows a diagram depicting a pressure distribution when an impact is applied to the head slider according to the first embodiment of the invention;

FIG. 8D shows a diagram depicting the configuration of the ABS surface of the head slider when the position of the step part in the longitudinal direction is 0.30 mm from the air inflow end in the first embodiment of the invention;

FIG. 8E shows a diagram depicting a pressure distribution of the head slider according to the first embodiment of the invention in normal floating;

FIG. 8F shows a diagram depicting a pressure distribution of the head slider according to the first embodiment of the invention when an impact is applied;

FIG. 9 shows a diagram depicting the configuration of a head slider in which a first positive pressure generating part and a second positive pressure generating part do not have an outside side rail parts in the first embodiment of the invention;

FIG. 10 shows a perspective view depicting the essential part of a disk drive apparatus according to a second embodiment of the invention; and

FIG. 11 shows a perspective view depicting the essential part of a head support unit according to the second embodiment of the invention.

### DESCRIPTION OF THE REFERENCE NUMERALS AND SIGNS

1, 51, 52, 61, 62, 85 head slider
2 first air bearing part
3 second air bearing part
4 first positive pressure generating part
5 second positive pressure generating part
6 base surface
7 first step part
8 second step part
9 first border part
10 second border part
11 step part
12 negative pressure generating part
13 side rail parts
14 outside side rail parts
20 inertia application point
21, 22, 41 positive pressure area
25 head part
30 recording medium
101 disk drive apparatus
103 main shaft
104 drive part
106 suspension
107 head support unit
108 actuator arm
109 actuator shaft
110 rotating part
111 case
112 slider holding part
113 tongue part
114 beam
115 pivot part

### MODE FOR CARRYING OUT THE INVENTION

Hereinafter, embodiments of the invention will be described in detail with reference to the drawings.

### First Embodiment

First, the structure of a floating head slider according to a first embodiment of the invention will be described.

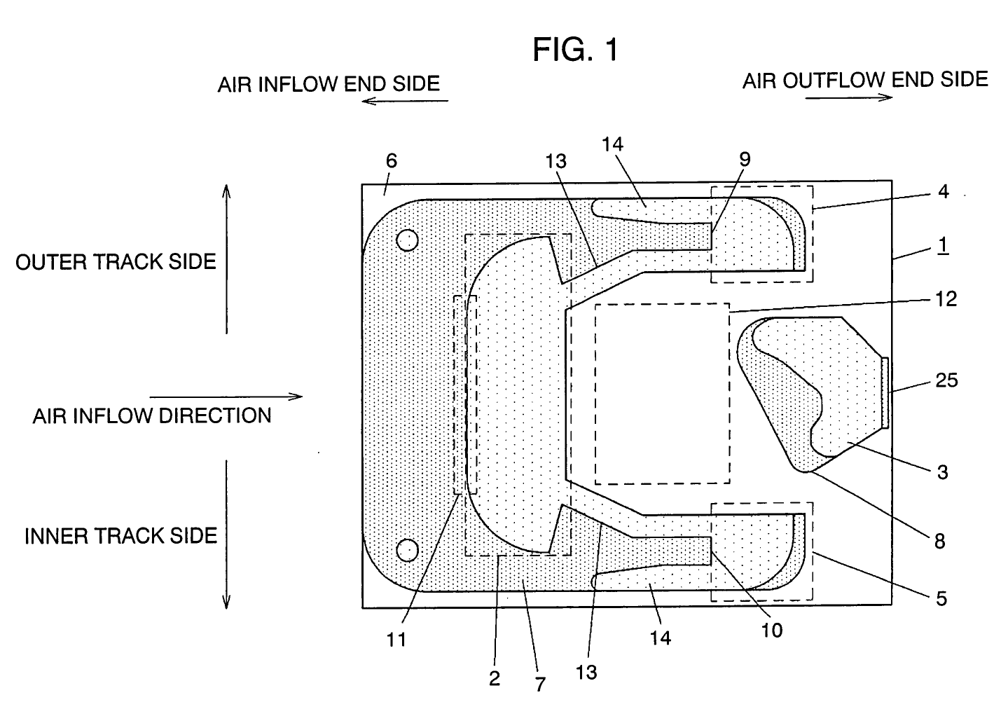

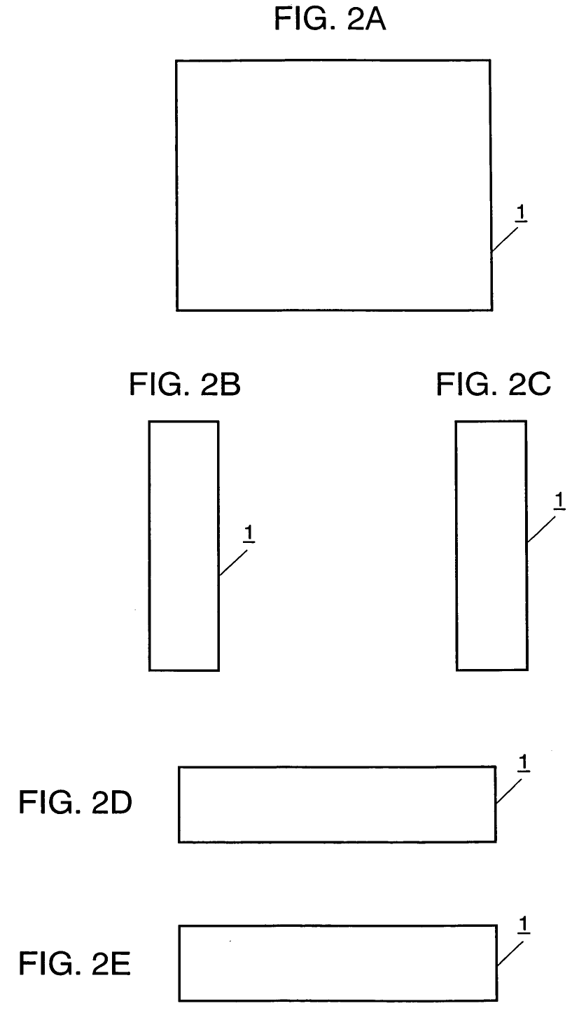

FIG. 1 shows a front view depicting the shape of an air lubrication surface (hereinafter, also denoted as an ABS surface) of floating head slider 1 according to the first embodiment of the invention (hereinafter, simply denoted as a head slider, omitting floating). As shown in FIG. 1, head slider 1 is configured in which air flows in from the left side on the paper surface. Hereinafter, in FIG. 1, the left side of head slider 1 on the paper surface is denoted as an air inflow end side, and the right side on the paper surface is denoted as an air outflow end side. As shown in FIG. 1, when head slider 1 is mounted on disk drive apparatus 101 (not shown), it is supposed to be placed in such a way that the upper direction thereof on the paper surface faces the outer track side of recording medium 30 (not shown), and the lower side thereof on the paper surface faces the inner track side of recording medium 30. Hereinafter, the upper side of head slider 1 on the paper surface in FIG. 1 is denoted as the outer track side, and the lower side is denoted as the inner track side. FIG. 2A shows a back side view depicting head slider 1, FIG. 2B shows a left side view depicting head slider 1, FIG. 2C shows a right side view depicting head slider 1, FIG. 2D shows a plan view depicting head slider 1, and FIG. 2E shows a bottom view depicting head slider 1.

As shown in FIG. 1, head slider 1 is configured to have a first step part 7 on base surface 6, first air bearing part 2, first positive pressure generating part 4 and second positive pressure generating part 5 on first step part 7, second step part 8, and second air bearing part 3 on second step part 8, in the order from the air inflow end side. Here, the air bearing part is the portion in which a positive pressure is generated in the space between head slider 1 and recording medium 30 facing thereto when head slider 1 is mounted on disk drive apparatus 1. The area of base surface 6 between first air bearing part 2 and second air bearing part 3 is positive pressure generating part 12 in which a positive pressure is generated.

Head slider 1 is a so-called FEMTO slider. In FIG. 1, the dimensions are as follows: the length in the longitudinal direction (air inflow direction)×the length in the short direction (the direction vertical to the air inflow direction)=0.85 mm×0.70 mm. In head slider 1, first air bearing part 2, first positive pressure generating part 4, second positive pressure generating part 5 and second air bearing part 3 are all in the same height from base surface 6. In head slider 1, the inner sides of first air bearing part 2 and first positive pressure generating part 4 are connected to each other, and the inner sides of first air bearing part 2 and second positive pressure generating part 5 are connected to each other through side rail parts 13, respectively. The height of side rail parts 13 from base surface 6 is also the same height of first air bearing part 2, first positive pressure generating part 4, second positive pressure generating part 5 and second air bearing part 3.

In head slider 1 according to the first embodiment of the invention 1, first step part 7 and second step part 8 are disposed at the same height from base surface 6.

Head slider 1 according to the first embodiment of the invention 1 has a height of 750 nm from base surface 6 to first step part 7 and second step part 8, and has a height of 70 nm from first step part 7 and second step part 8 to first air bearing part 2, second air bearing part 3 and side rail parts 13. For example, head slider 1 can be produced by etching.

In the embodiment, the border portion on the air inflow end side between first step part 7 and first air bearing part 2 of head slider 1 (the position 0.16 mm from the air inflow end) is denoted as step part 11, and the border areas between first step part 7 in the U-shaped area and first positive pressure generating part 4 and second positive pressure generating part 5 (the position 0.56 mm from the air inflow end) are denoted as first border part 9 and second border part 10, respectively. The positions in the longitudinal direction of first border part 9 and second border part 10 in head slider 1 are supposed to be nearly matched with each other. The positions in the longitudinal direction of first border part 9 and second border part 10 in head slider 1 are matched with each other, whereby the configuration can be implemented which has excellent balance in floating.

Head slider 1 has head part 25 on the outermost air outflow end side of second air bearing part 3. Second air bearing part 3 has an asymmetrical shape with respect to the center axis of head slider 1 in the longitudinal direction. This shape is designed for suppressing fluctuations in the floating amount depending on the difference between the air inflow rate on the inner track side and the air inflow rate on the outer track side of recording medium 30 when head slider 1 is mounted on disk drive apparatus 101.

On the outside of first positive pressure generating part 4 and second positive pressure generating part 5 of head slider 1, outside side rail parts 14 are disposed. In head slider 1 according to the first embodiment of the invention 1, the air flow is compressed in the area surrounded by outside side rail parts 14, first border part 9, second border part 10 and side rail parts 13, whereby a positive pressure can be generated more effectively in first border part 9 and second border part 10.

The crown amount of head slider 1 in the longitudinal direction is 13 nm. As the crown amount is greater, the fluctuations in the pitch angle can be made greater. The camber amount of head slider 1 in the short direction is 0 nm.

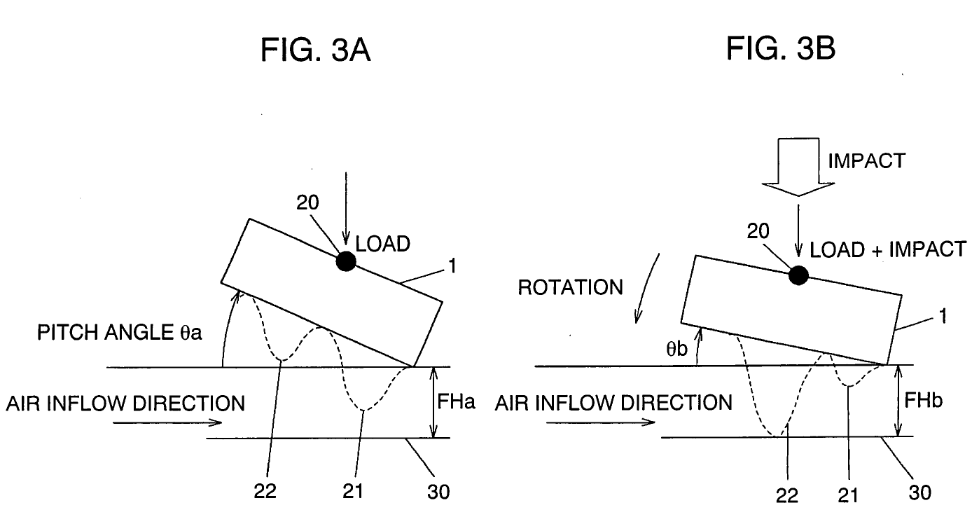

Next, the behavior of the head slider 1 according to the first embodiment of the invention will be described when it is mounted on disk drive apparatus 101. FIGS. 3A and 3B show diagrams depicting the behavior when head slider 1 is floating. FIG. 3A shows a diagram depicting the behavior in normal stable floating, and FIG. 3B shows a diagram depicting the behavior when an external impact is applied. In FIGS. 3A and 3B, it is supposed that air flows in from the left side on the paper surface.

First, as shown in FIG. 3A, head slider 1 can stably floats over recording medium 30 while recording medium 30 is rotating, in the sate in which the balance is achieved between the pressing force caused by the load applied to inertia application point 20 (in the embodiment, the center point of the back side of the air lubrication surface of head slider 1) in the direction in which head slider 1 comes close to recording medium 30 from head support unit 107 (not shown) and the floating force working in the direction in which head slider 1 is separated from recording medium 30 caused by the air flow flowing into between head slider 1 and recording medium 30. As shown in FIG. 1, in head slider 1, the area of first air bearing part 2 is greater than the area of second air bearing part 3. Thus, the pressure generated in first air bearing part 2 becomes greater than the pressure generated in second air bearing part 3. Because of the pressure difference, head slider 1 can float stably over the surface of recording medium 30 as positive pitch angle θa is maintained with respect thereto.

In head slider 1, head part 25 is disposed on the air outflow end side of second air bearing part 3. Head slider 1 is supported by pressure area (hereinafter, denoted as the positive pressure area) 21 generated by second air bearing part 3, and head part 25 can float with no collide against recording medium 30 as floating amount FHa (see FIG. 3A) is maintained over recording medium 30.

Subsequently, as shown in FIG. 3B, when an external impact is applied to inertia application point 20 in association with disk drive apparatus 101 dropped, head slider 1 moves as it rotates counterclockwise in the drawing, head slider 1 keeps floating as pitch angle θb is maintained with respect to the recording surface of recording medium 30, the pitch angle is smaller than pitch angle θa in stable floating. In the first embodiment of the invention, since the position of step part 11 in the border area between first air bearing part 2 and first step part 7 is configured to come into the inner side more than the air inflow end side to some extent (it is separated therefrom), head slider 1 is configured to easily rotate in the pitch direction when an impact is applied thereto.

In head slider 1, when an external impact is applied as shown in FIG. 3B, the pressure in positive pressure area 22 generated by first border part 9 of first positive pressure generating part 4 and second border part 10 of second positive pressure generating part 5 become higher than in usual, whereby head slider 1 can float with no collide against recording medium 30 as floating amount FHb is maintained as though head slider 1 were supported by air bearings in positive pressure areas 22.

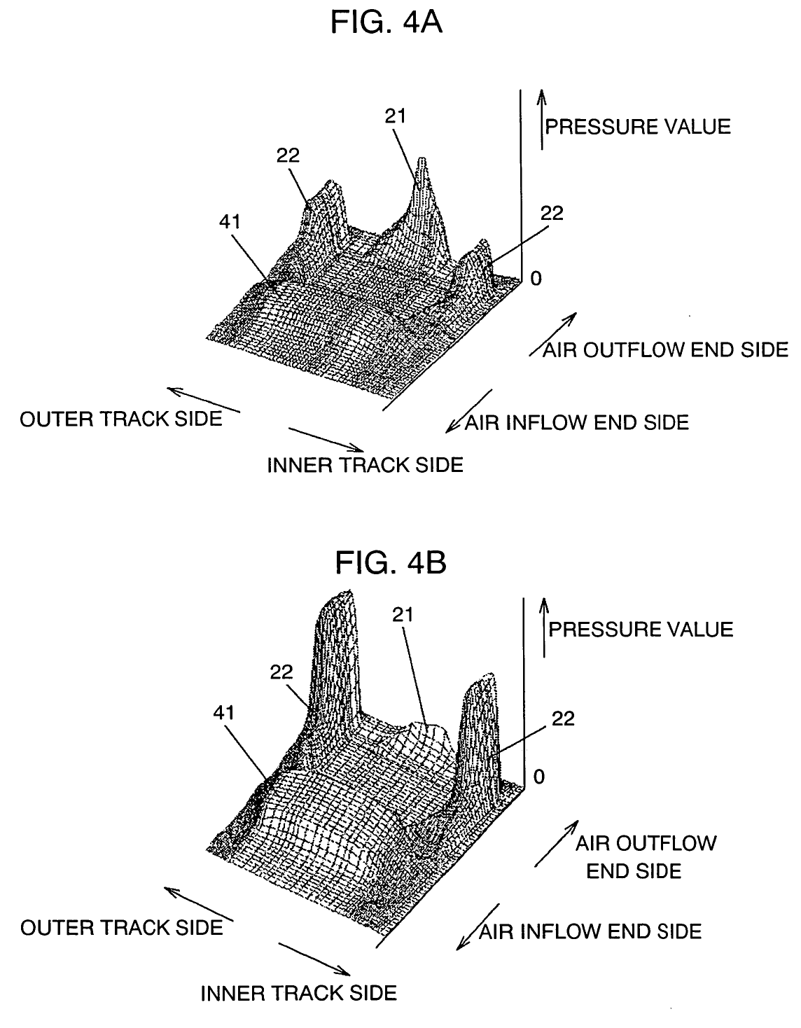

Here, a pressure distribution generated by head slider 1 between itself and recording medium 30 will be described in more detail. FIGS. 4A and 4B show diagrams depicting a pressure distribution generated between head slider 1 and recording medium 30. FIG. 4A shows a diagram depicting a pressure distribution in normal floating, and FIG. 4B shows a diagram depicting a pressure distribution when an impact is applied. In FIGS. 4A and 4B, the pressure distribution generated between the ABS surface of head slider 1 and recording medium 30 is depicted in a three-dimensional graph, depicting that the relative pressure value is positive on the upper side of the paper surface (higher than the atmospheric pressure) and the relative pressure value is negative on the lower side (lower than the atmospheric pressure). For example, the computation of the pressure distribution can be performed with the use of a design program (CML Air Bearing Design Program) developed by the University of California, Berkeley. Computation was performed where the normal load: 1.5 gf, the load when an impact is applied: 10 gf (equivalent to an impact of about 5300 G), the radius: 9 mm, the number of revolutions: 3600 r/m, the skew angle: 6.44°, and the target floating amount: 10 nm, for the conditions of simulations. Here, impact G when an impact is applied was computed based on the flowing equation:

G=((10−1.5)/(1.6×0.001))=5312.5(G)

where the mass of head slider 1 is 1.6 mg. An impact of 5300 G is equivalent to an impact applied to disk drive apparatus 101 when the apparatus is directly dropped onto a concrete floor from a height of about 1.5 m (it is supposed to be dropped from hands of a person standing) with no cushioning material between disk drive apparatus 101 and the information device, as described above. Head slider 1 floats without contacting with recording medium 30 against this impact, that is, it can be considered that an impact resistance of 5300 G is provided.

As shown in FIG. 4A, it is revealed that four positive pressure areas 21, 22 (two) and 41 are generated between head slider 1 and recording medium 30 while head slider 1 is stably floating. These four positive pressure areas 21, 22 and 41 are generated between second air bearing part 3 and recording medium 30, between first and second positive pressure generating parts 4 and 5 and recording medium 30, and between first air bearing part 2 and recording medium 30, as a consequence of the compressed air flow. As shown in FIG. 4A, while head slider 1 is stably floating, the pressure value of positive pressure area 21 (for an example, the maximum value of the peak forming the positive pressure area) generated between second air bearing part 3 and recording medium 30 is higher than the pressure values of positive pressure area 22 generated between first positive pressure generating part 4 and recording medium 30 and between second positive pressure generating part 5 and recording medium 30, and the pressure value of positive pressure area 41 generated between first air bearing part 2 and recording medium 30. As described above, it is revealed that head slider 1 is floating in normal stable floating as the pressure generated between second air bearing part 3 and recording medium 30 is the highest. Therefore, in normal operation, head slider 1 is supported by the air bearing of positive pressure area 21, and floats with no contact with recording medium 30. On the other hand, when head slider 1 receives an external impact, as shown in FIG. 4B, the pressure values of positive pressure areas 22, that is, the pressure values of positive pressure generated between first positive pressure generating part 4 and recording medium 30 and between second positive pressure generating part 5 and recording medium 30 are greater than the pressure value of positive pressure area 21. It is revealed that the pressure value of positive pressure area 21 generated between second air bearing part 3 and recording medium 30 when an impact is applied is smaller than the pressure value of positive pressure area 21 in normal floating shown in FIG. 4A. As shown in FIGS. 3A and 3B, head slider 1 rotates in the pitch direction in which the pitch angle is reduced and absorbs an impact when the impact is applied. Thus, it can be considered that the distance between second air bearing part 3 and recording medium 30 is slightly increased, which thus reduces the pressure value of positive pressure area 21 generated between second air bearing part 3 and recording medium 30. Head slider 1 shows the behavior that it rotates in the pitch direction as though it is supported by the air bearings in positive pressure areas 22 having an increased pressure value when an impact is applied. Therefore, head slider 1 hardly collides against recording medium 30 even when an impact is applied.

As described above, in head slider 1 according to the first embodiment of the invention 1, in normal floating, the pressure value of positive pressure area 21 generated between second air bearing part 3 and recording medium 30 is higher than the pressure values of positive pressure areas 22 generated between first positive pressure generating part 4 and recording medium 30 and between second positive pressure generating part 5 and recording medium 30, respectively. On the other hand, when an impact is applied to head slider 1, the pressure values of positive pressure areas 22 generated between first positive pressure generating part 4 and recording medium 30 and between second positive pressure generating part 5 and recording medium 30, respectively, are higher than the pressure value of positive pressure area 21 generated between second air bearing part 3 and recording medium 30, and head slider 1 can absorb an impact as it rotates in the pitch direction as though it were supported by the air bearings in positive pressure areas 22. According to computation, even though an impact of about 5300 G is applied, a high impact resistance can be implemented with no collision against recording medium 30 by head slider 1.

Next, the conditions of head slider 1 which can implement such a high impact resistance will be described. First, in head slider 1, the positions in the longitudinal direction of first border part 9 of first positive pressure generating part 4 and second border part 10 of second positive pressure generating part 5 of head slider 1 affect the impact resistance of head slider 1.

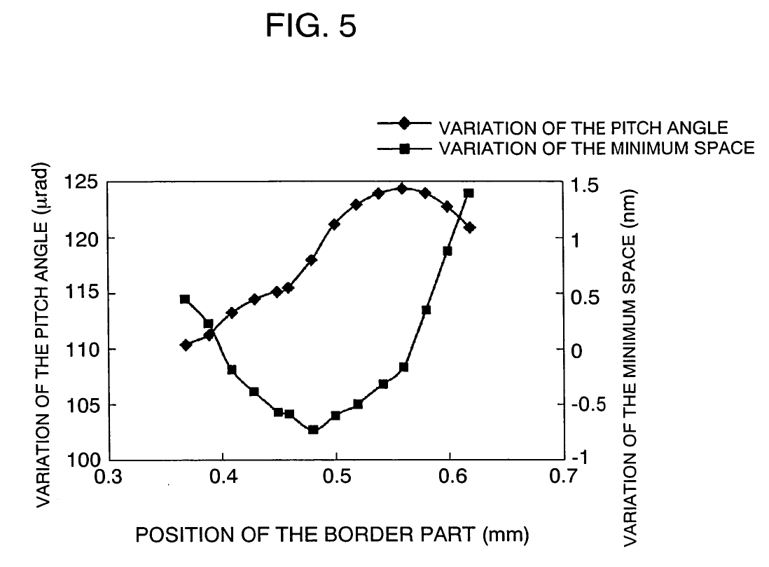

FIG. 5 shows a diagram depicting the relationship between the positions in the longitudinal direction of first border part 9 and second border part 10 of head slider 1 and the variations of the minimum space and the pitch angle when an impact is applied. The unit of the pitch angle is denoted by μrad, and the unit of the variation of the minimum space is denoted by nm. The variation of the minimum space being the positive value shows the direction in which the minimum space between head slider 1 and recording medium 30 is reduced (the direction in which head slider 1 comes closer to recording medium 30), whereas the variation of the minimum space being the negative value shows the direction in which the minimum space between head slider 1 and recording medium 30 is increased (the direction in which head slider 1 is separated from the recording medium). Therefore, it is desirable that the value of the minimum space is not changed, or the variation of the minimum space is the negative value.

As shown in FIG. 5, it is revealed that in head slider 1, the positions in the longitudinal direction of first border part 9 and second border part 10 from the air inflow end side are moved to change the variation of the value of the minimum space as well. As shown in FIG. 5, in head slider 1 (the length in the longitudinal direction is 0.85 mm), the variation of the minimum space is the minimum value (−0.75 nm) when the positions in the longitudinal direction of first border part 9 and second border part 10 are about 0.48 mm from the air inflow end, and the variation of the minimum space takes the negative value, that is, the minimum space is varied in the direction in which head slider 1 is separated from recording medium 30 when the positions in the longitudinal direction of first border part 9 and second border part 10 are from 0.4 mm to 0.56 mm inclusive, from the air inflow end. Therefore, the possibility of contacting head slider 1 with recording medium 30 can be further reduced. The variation of the minimum space is “0” when the positions in the longitudinal direction of first border part 9 and second border part 10 are 0.4 mm and 0.56 mm from the air inflow end. Therefore, it can be said that head slider 1 of the most excellent impact resistance can be obtained.

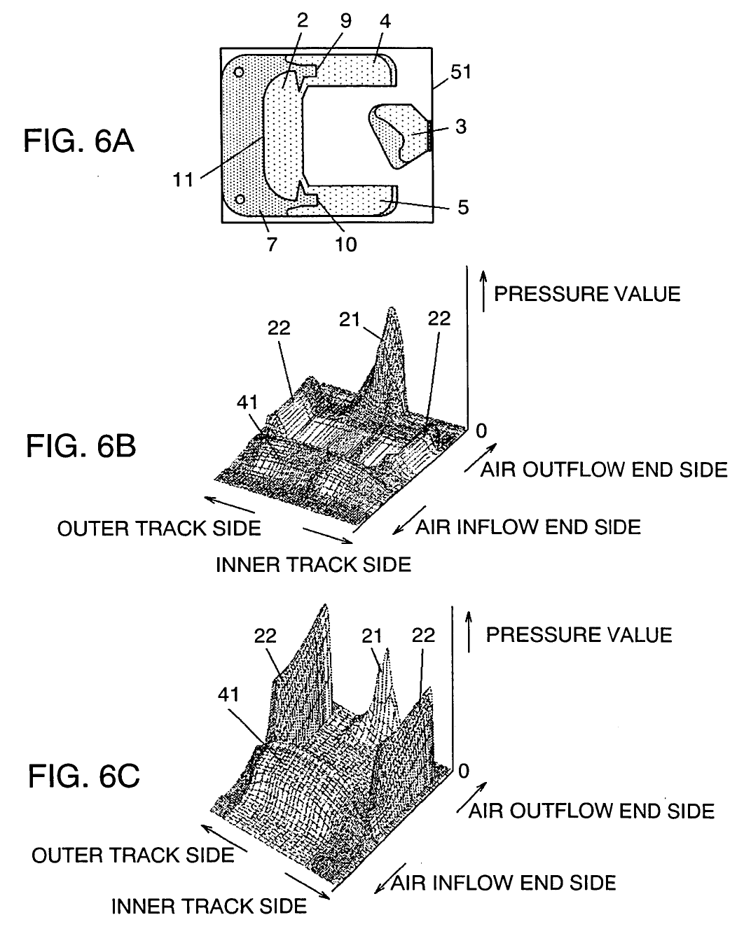

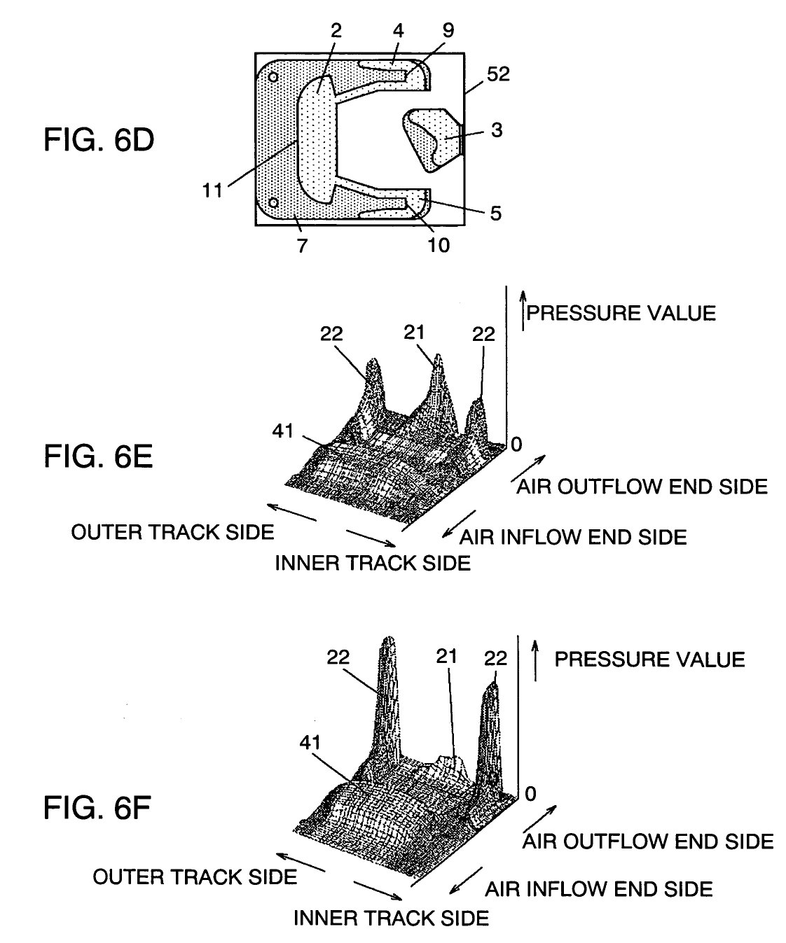

FIGS. 6A to 6F show a pressure distribution when the positions in the longitudinal direction of first border part 9 and second border part 10 satisfy the conditions described above in head slider 1 for verification. FIG. 6A shows a diagram depicting the configuration of the ABS surface of head slider 51 when the positions in the longitudinal direction of first border part 9 and second border part 10 are 0.4 mm from the air inflow end, FIG. 6B shows a diagram depicting a pressure distribution of head slider 51 in normal floating, and FIG. 6C shows a diagram depicting a pressure distribution when an impact is applied to head slider 51. FIG. 6D shows a diagram depicting the configuration of the ABS surface of head slider 52 when the positions in the longitudinal direction of first border part 9 and the second border part 10 are 0.56 mm from the air inflow end, FIG. 6E shows diagram depicting a pressure distribution of head slider 52 in normal floating, and FIG. 6F shows a diagram depicting a pressure distribution when an impact is applied to head slider 52.

First, as shown in FIGS. 6B and 6E, in the both cases in which the positions in the longitudinal direction of first border part 9 and second border part 10 are 0.40 mm and 0.56 mm from the air inflow end, in normal floating, the pressure value of positive pressure area 21 generated between second air bearing part 3 and recording medium 30 is higher than the pressure values of positive pressure areas 22 generated between first positive pressure generating part 4 and recording medium 30 and between second positive pressure generating part 5 and recording medium 30. Both of head sliders 51 and 52 can stably float in normal floating as head part 25 mounted on second air bearing part 3 is prevented from being contacted with recording medium 30.

As shown in FIGS. 6C and 6F, in the both cases in which the positions in the longitudinal direction of first border part 9 and second border part 10 are 0.40 mm and 0.56 mm from the air inflow end, when an impact is applied, the pressure values of positive pressure areas 22 generated between first positive pressure generating part 4 and recording medium 30 and between second positive pressure generating part 5 and recording medium 30 are greater than the pressure value of positive pressure area 21 generated between second air bearing part 3 and recording medium 30. Both of head sliders 51 and 52 can absorb an impact as they rotate in the pitch direction as though they are supported by the air bearings generated in positive pressure areas 22 when an impact is applied. Accordingly, as described above, it can be said that head sliders 1, 51 and 52 all have the configuration excellent in impact resistance in which the positions in the longitudinal direction of first border part 9 and second border part 10 are positioned in the range of 0.40 mm to 0.56 mm. In this range, as shown in FIG. 5, it is revealed that as the positions in the longitudinal direction of first border part 9 and second border part 10 are more separated from the air outflow end side, the variations of the pitch angle of head sliders 1, 51 and 52 are greater.

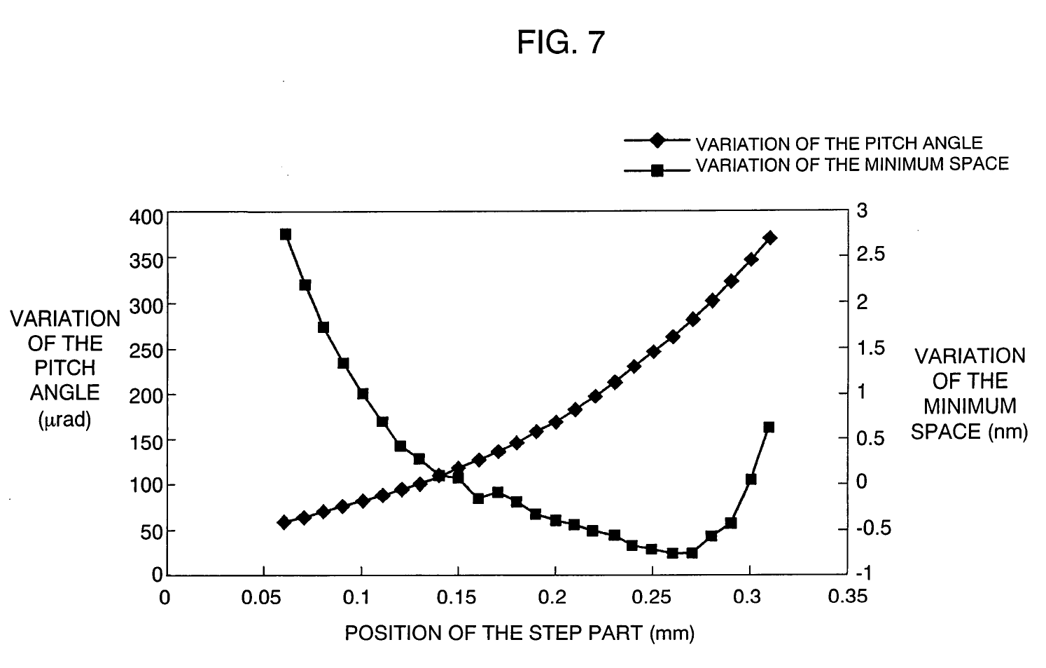

Then, the position of step part 11 between first step part 7 and first air bearing part 2 of head slider 1 also affects the impact resistance of head slider 1. FIG. 7 shows a diagram depicting the relationship between the position of step part 11 of head slider 1 according to the first embodiment of the invention 1 from the air inflow end and the variations of the pitch angle and the minimum space. In an example shown in FIG. 7, computation is performed as the above-described positions of first border part 9 and the second border part 10 are fixed to 0.56 mm from the air inflow end.

As shown in FIG. 7, in head slider 1 according to the first embodiment of the invention 1, it is revealed that there is correlation between the position of step part 11 and the variation value of the minimum space. When the position of step part 11 of head slider 1 is about 0.26 mm from the air flow end in the longitudinal direction, the variation of the minimum space is the smallest, −0.75 nm, and the variation of the minimum space takes a negative value in the rage that the position of step part 11 is from 0.15 mm to 0.30 mm from the air inflow end, that is, the minimum space is varied in the direction in which head slider 1 is separated from recording medium 30. Therefore, the configuration more excellent in impact resistance can be implemented.

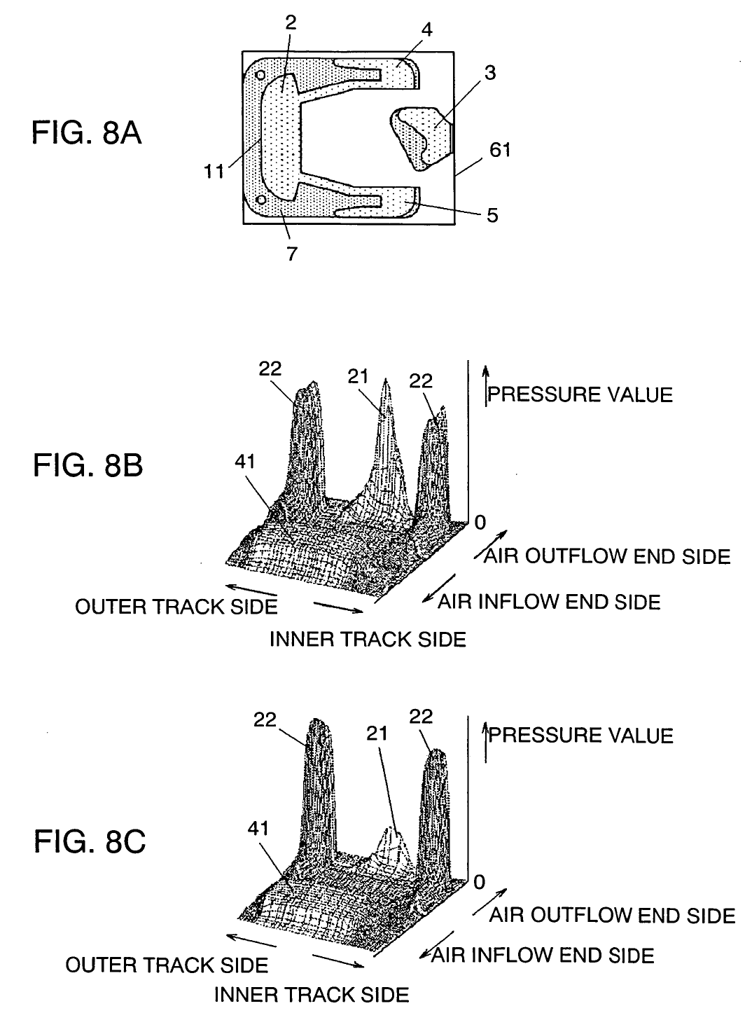

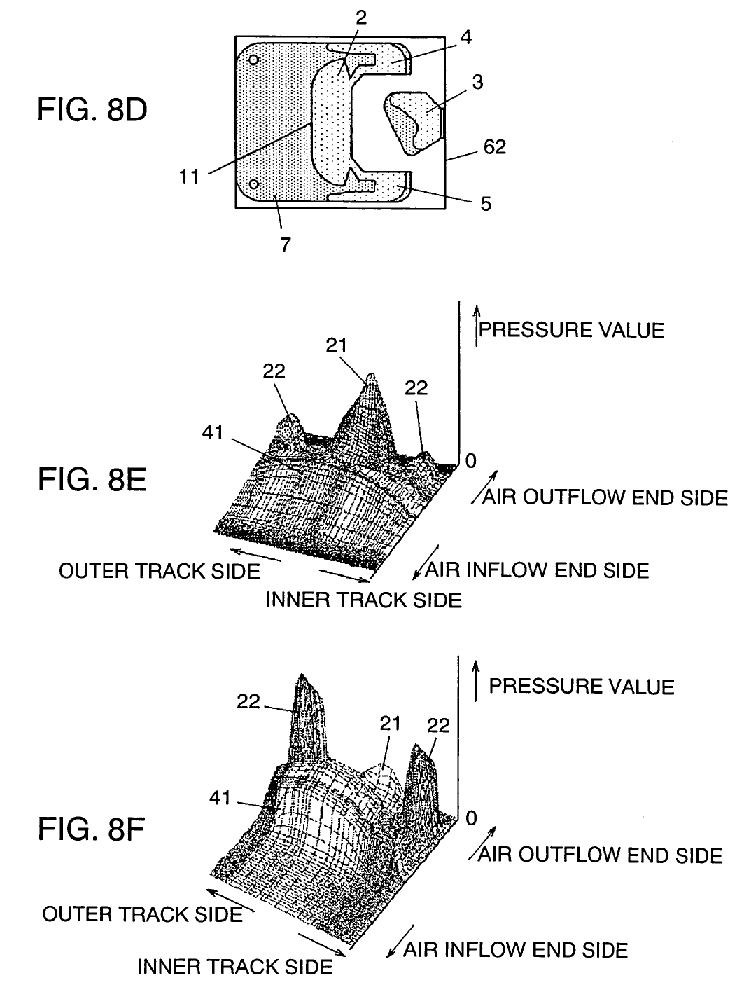

FIGS. 8A to 8F show a pressure distribution when the position in the longitudinal direction of step part 11 satisfies the above-described conditions in head slider 1 for verification. FIG. 8A shows a diagram depicting the configuration of the ABS surface of head slider 61 when the position in the longitudinal direction of step part 11 is 0.15 mm from the air flow end, FIG. 8B shows a diagram depicting a pressure distribution of head slider 61 in normal floating, and FIG. 8C shows a diagram depicting a pressure distribution when an impact is applied to head slider 61. FIG. 8D shows a diagram depicting the configuration of the ABS surface of head slider 62 when the position in the longitudinal direction of step part 11 is 0.30 mm from the air inflow end, FIG. 8E shows a diagram depicting a pressure distribution of head slider 62 in normal floating, and FIG. 8F shows a diagram depicting a pressure distribution when an impact is applied to head slider 62.

First, as shown in FIGS. 8B and 8E, in the both cases in which the position in the longitudinal direction of step part 11 is 0.15 mm and 0.30 mm from the air inflow end, in normal floating, the pressure value of positive pressure area 21 generated between second air bearing part 3 and recording medium 30 is greater than the pressure values of positive pressure areas 22 generated between first positive pressure generating part 4 and recording medium 30 and between second positive pressure generating part 5 and recording medium 30. Both of head sliders 61 and 62 can stably float in normal floating as head part 25 mounted on second air bearing part 3 can be prevented from being contacted with recording medium 30.

As shown in FIGS. 8C and 8F, when an impact is applied, in the both cases in which the position in the longitudinal direction of step part 11 is 0.15 mm and 0.30 mm from the air inflow end, the pressure values of positive pressure areas 22 generated between first positive pressure generating part 4 and recording medium 30 and between second positive pressure generating part 5 and recording medium 30 are greater than the pressure value of positive pressure area 21 generated between second air bearing part 3 and recording medium 30. Both of head sliders 61 and 62 can absorb an impact as they rotate in the pitch direction as though they are supported by the air bearings generated in positive pressure area 22 when an impact is applied. Therefore, head slider 1 is not contacted with recording medium 30. Accordingly, as described above, it can be said that head sliders 1, 61 and 62 all have the configuration excellent in impact resistance in which the positions in the longitudinal direction of first border part 9 and second border part 10 are positioned in the range of 0.15 mm to 0.30 mm. In this range, as shown in FIG. 7, as the position in the longitudinal direction of step part 11 is more separated from the air outflow end side, the variations of the pitch angle of head sliders 1, 61 and 62 are greater.

As described above, in head slider 1, distance D1 between first border part 9 and second border part 10 from the air inflow end is set as:

0.40 mm≦D1≦0.56 mm (1)

and, distance D2 of the step part 11 from the air inflow end is set as:

15 mm≦D2≦0.30 mm (2).

Thus, head slider 1 of the most excellent impact resistance can be implemented.

As described above, head slider 1 is an FEMTO slider, and the length in the longitudinal direction is 0.85 mm. Thus, when Equation (1) and Equation (2) are normalized by the length of head slider 1, the following equations can be obtained, where the length of head slider 1 in the longitudinal direction is DT:

(0.40/0.85)≦(D1/DT)≦(0.56/0.85) (3), and

(0.15/0.85)≦(D2/DT)≦(0.30/0.85) (4)

When they are computed, the following equations are obtained:

0.47≦(D1/DT)≦0.66 (5)

0.18≦(D2/DT)≦0.35 (6)

It can be said that head slider 1 which satisfies the relationships of Equation (5) and Equation (6) is the head slider excellent in impact resistance.

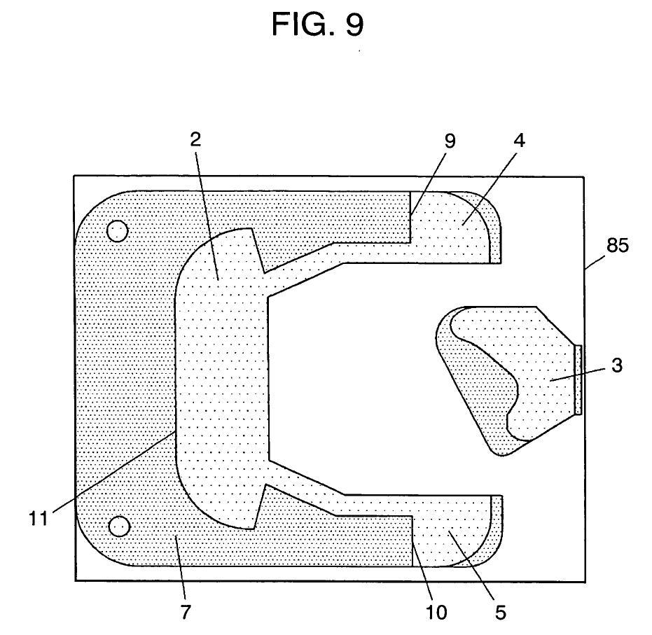

In the first embodiment of the invention, the example is taken and described that first positive pressure generating part 4 and second positive pressure generating part 5 each have outside side rail parts 14 outside with respect to the center axis in the longitudinal direction of head slider 1, but the invention is not limited to this example. For example, as head slider 85 shown in FIG. 9, even though first positive pressure generating part 4 and second positive pressure generating part 5 are configured not to have outside side rail parts 14, as similar to head slider 1, when an impact is applied, a high pressure is generated from first positive pressure generating part 4 and the second positive pressure generating part 5 to form air bearings, whereby the configuration excellent in impact resistance can be implemented.

In the first embodiment of the invention, the head slider for the magnetic disk drive apparatus is explained, but the purpose of the head slider according to the invention is not limited for use in the magnetic disk drive apparatus. For example, it includes floating head sliders for use in a magneto-optic disk drive apparatus, an optical disk drive apparatus, etc.

In the first embodiment of the invention, it is described based on simulation results under predetermined conditions, but the floating head slider according to the invention is not limited to the number of revolutions, loads, the size of the head slider, and so on in the simulation.

For example, the head slider according to the invention shows excellent impact resistance in the number of revolutions for practical use in the magnetic disk drive apparatus. The floating head slider according to the invention can show the above-described excellent impact resistance also in the number of revolutions as relatively low as about 2000 to 5000 rpm for general use in a small-sized magnetic disk drive apparatus.

In the first embodiment of the invention, the size is used for explanation: the length in the longitudinal direction (the air inflow direction)×the length in the short direction (the direction vertical to the air inflow direction)=0.85 mm×0.70 mm (a so-called 20% slider or FEMTO slider), but the size of the head slider according to the invention is not limited to that size. As an example, the same advantage can be obtained as well with the use of a head slider so-called 30% slider or PICO slider.

The load of the head slider according to the invention is not limited to the above-described load when used. As an example, when the above-described PICO slider or FEMTO slider is used, it can be used in the load ranging from 0.5 g to 2.5

### Second Embodiment

Head support unit 107 and disk drive apparatus 101 according to a second embodiment of the invention will be described in detail with reference to the drawings.

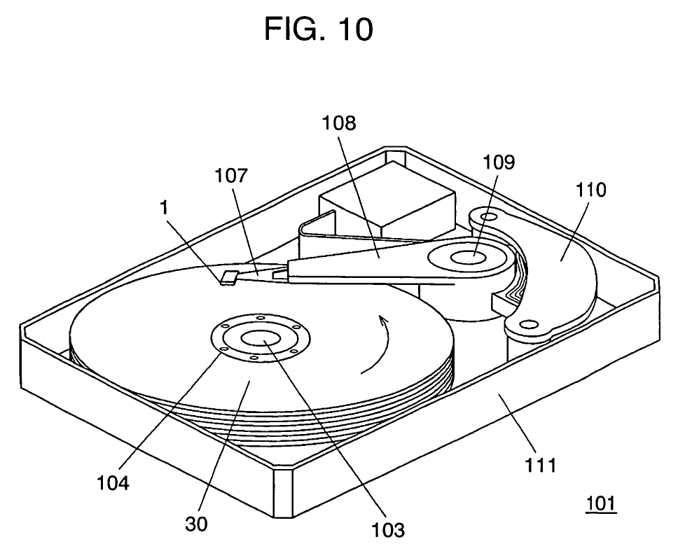

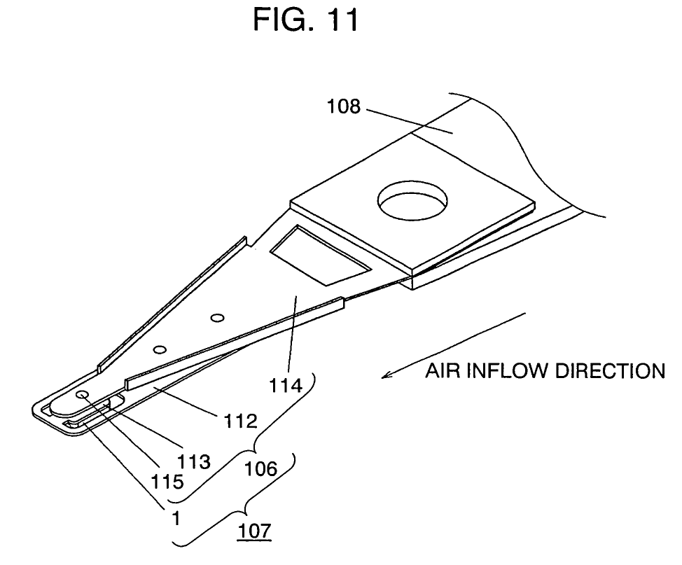

FIG. 10 shows a perspective view depicting the essential part of disk drive apparatus 101. Here, for an example of disk drive apparatus 101, a magnetic disk drive apparatus is used for illustration. FIG. 11 shows a perspective view depicting the essential part of head support unit 107.

In disk drive apparatus 101 shown in FIG. 10, recording medium (disk-shaped recording medium) 30 is rotatably supported on main shaft 103, and is rotated and driven by drive part 104. For this drive part 104, for example, a spindle motor can be used.

Head slider 1 provided with head part 25 (not shown) which records and plays back on recording medium 30 is mounted on a suspension to form head support unit 107. Head support unit 107 is fixed on actuator arm 108. Actuator arm 108 is mounted on actuator shaft 109 which is rotatably mounted on rotating part 110. The rotation and drive of drive part 104 and the rotation of rotating part 110 are controlled by a control part (not shown).

It is supposed that head slider 1 according to the second embodiment of the invention is configured to have an ABS surface described in the first embodiment of the invention shown in FIG. 1, and satisfies Equation (5) and Equation (6) described above.

For rotating part 110, for example, a voice coil motor can be used. Actuator arm 108 is rotated to move head slider 1 at a given track position over the surface of recording medium 30. Case 111 maintains these components in a predetermined position relationship, and holds them.

FIG. 11 shows a perspective view depicting the essential part of head support unit 107 having suspension 106 and head slider 1. Head slider 1 is fixed on tongue part 113 which is disposed at one end of the sip end sides of slider holding part 112. The other end of slider holding part 112 is fastened to beam 114.

For slider holding part 112, for example, a gimbal spring is used to accept the pitch operation and rolling operation of head slider 1. For fixing head slider 1 to slider holding part 112, for example, it is done by adhesion with an adhesive. For fastening slider holding part 112 to beam 114, for example, it is done by welding. At the tip end of beam 114, pivot part 115 is provided which energizes a load to head slider 1, and head slider 1 is energized with a predetermined load through pivot part 115. The point at which pivot part 115 is abutted against head slider 1, that is, the pivot position becomes inertia application point 20 as described in the first embodiment. More specifically, the point is the working point at which an inertial force is applied when the inertial force such as an impact caused by disturbance or the like is applied to head slider 1.

At this time, head support unit 107 is configured so that the position of the center of gravity and the pivot position of head slider 1 projected onto the surface of recording medium 30 are matched with each other, whereby the generation of the moment of inertia can be prevented. Therefore, head support unit 107 of the most excellent impact resistance can be obtained.

When head support unit 107 like this is used to record and reproduce on rotating recording medium 30, head slider 1 is applied with three forces, the load applied from pivot part 115 as well as the positive pressure working in the direction in which head slider 1 is floated over recording medium 30 by an air flow and the negative pressure working in the direction in which head slider 1 is brought closer to recording medium 30 in accordance with the design of the air lubrication surface of head slider 1. Head slider 1 stably floats by the balance of these forces, rotating part 110 is driven in the state that the floating amount is held constantly, and at least one of recording and reproducing can be done by head part 25 on recording medium 30 as head slider 1 is positioned at a desired track position.

With the use of head support unit 107 mounted with head slider 1 thus configured and disk drive apparatus 101, a head support unit and a disk drive apparatus excellent in impact resistance can be obtained.

The invention is not at all limited to the magnetic disk drive apparatus shown as an example, which can be adapted to a disk drive apparatus using a floating head slider such as a magneto-optic disk drive apparatus and an optical disk drive apparatus.

The invention is not limited to the disk drive apparatus using a disk-shape medium, which can be adapted to a recording and reproducing apparatus using a medium in any shapes.

As described above, with the use of the head slider according to the invention, even when an inertial force having an acceleration as great as about 5300 G is applied to the head slider, the floating head slider can be implemented in which the head slider can stably float over the disk-shaped recording medium with no collide against the disk-shaped recording medium.

The head slider according to the invention is used to configure a head support unit and a disk drive apparatus, whereby a head support unit and a disk drive apparatus of high impact resistance can be provided which can prevent an impact of the head slider against the surface of the recording medium even though an inertial force caused by a great external impact is applied while the head slider is floating over a disk.

### INDUSTRIAL APPLICABILITY

As described above, according to the invention, an advantage is provided that at least one of the recording and reproducing of information can be done even when the apparatus is directly dropped onto a concrete floor from a height of about 1.5 m high, for example, (it is supposed to be dropped from hands of a person standing) in a state with no cushioning material between the disk drive apparatus and the information device. Therefore, it is useful as a floating head slider, ahead support unit using the floating head slider, and a disk drive apparatus mounted with the head support unit using the floating head slider.

1. A head slider which has a head part and which performs at least one of recording and reproducing by the head part in a state in which the head slider floats over a recording medium, which comprising:
a first air bearing part which is disposed on an air inflow end side on a base surface;
a second air bearing part which is disposed closer to an air outflow end side than the first air bearing part on the base surface and which has the head part and has an area smaller than that of the first air bearing part;
a pair of positive pressure generating parts which is disposed on both sides of a center axis of the head slider in the longitudinal direction closer to the air outflow end side than a step part formed between the first air bearing part and the base surface on the air inflow end side;
a side rail parts which are disposed between the first air bearing part and one positive pressure generating part of the pair of positive pressure generating parts, and between the first air bearing part and the other positive pressure generating part of the pair of positive pressure generating parts; and
an outside side rail parts which are disposed outside the pair of positive pressure generating parts with respect to the center axis of the head slider in the longitudinal direction.

2. The head slider of claim 1, further comprising:
a first step part which is disposed between the base surface and the first air bearing part; and
a second step part which is disposed between the base surface and the second air bearing part.

3. The head slider of claim 1, wherein a negative pressure generating part is provided in an area surrounded by the first air bearing part, the second air bearing part, and the side rail parts.

4. The head slider of claim 1, wherein the first air bearing part, the second air bearing part, the side rail parts, the outside side rail parts and the pair of positive pressure generating parts are formed at the same height from the base surface.

5. The head slider of claim 2, wherein the first step part and the second step part are formed at the same height from the base surface.

6. The head slider of claim 1, wherein distance D1 in the longitudinal direction from the air inflow end of the head slider to a border part of the pair of positive pressure generating parts on the air inflow end side satisfies a relationship below where a length of the head slider in the longitudinal direction is DT:
0.47≦(D1/DT)≦0.66

7. The head slider of claim 6, wherein distance D2 in the longitudinal direction from the air inflow end of the head slider to the step part of the first air bearing part satisfies a relationship below where a length of the head slider in the longitudinal direction is DT:
0.18≦(D2/DT)≦0.35

8. A head support unit comprising:
the head slider of claim 1; and
a suspension which applies a predetermined thrusting force with respect to the head slider from a side opposite to a side on which the first air bearing part and the second air bearing part are disposed on the base surface.

9. The head support unit of claim 8, wherein the suspension has a pivot part which applies the predetermined thrusting force with respect to the head slider.

10. A disk drive apparatus comprising:
the head support unit of claim 8;
a disk-shaped recording medium;
a drive part which rotates and drives the disk-shaped recording medium;
a rotating part which rotates the suspension of the head support unit in a radial direction of the disk-shaped recording medium; and
a control part which controls the rotation and drive of the drive part and the rotation of the rotating part.

11. The disk drive apparatus of claim 10,
wherein the suspension of the head support unit has a pivot part which applies a predetermined thrusting force with respect to the head slider;
wherein when a position at which the pivot part is abutted against the head slider is set to a pivot position, the position of the center of gravity and the pivot position of the head slider projected onto the disk-shaped recording medium are matched with each other.
